(19) United States
(12) Patent Application Publication
(10) Pub. No.: US 2026/0064753 A1
(43) Pub. Date: Mar. 5, 2026

(54) EFFECTIVE LLM PROMPT CREATION FOR MULTI-DIMENSIONAL DATA ANALYSIS

(71) Applicant: Oracle International Corporation, Redwood Shores, CA (US)

(72) Inventors: Prakash Khubchandani, Danbury, CT (US); Abhishek Porwal, Karnataka (IN); Shifu Jain, Harding Township, NJ (US)

(73) Assignee: Oracle International Corporation, Redwood Shores, CA (US)

(21) Appl. No.: 19/169,165

(22) Filed: Apr. 3, 2025

Related U.S. Application Data
(60) Provisional application No. 63/688,380, filed on Aug. 29, 2024.

(51) Int. Cl. G06F 16/34; G06F 16/334

(52) U.S. Cl. CPC G06F 16/345; G06F 16/334

(57) ABSTRACT

Systems, methods, and computer-readable media are provided for detecting an anomaly involving multiple dimensions, and generating a summary of the anomaly at least in part by prompting an LLM with key-value pairs relevant to the anomaly. The key-value pairs provided may be determined by drilling down into dimensional members most relevant to the anomaly (e.g., Top N and/or Bottom N members) to provide context for the LLM to summarize the anomaly and account for various levels in a multidimensional hierarchy. The key-value pairs may additionally or alternatively be determined by comparing values from different times relevant to the anomaly to provide context for the LLM to summarize the anomaly and account for relevant time variances. The key-value pairs of the Top N and/or Bottom N members and/or time variant comparison values may be included to enrich the LLM's summary to account for the multidimensional hierarchy and/or relevant time variances without overwhelming the LLM with extraneous information.

### CROSS-REFERENCE TO RELATED APPLICATION(S)

This application claims the benefit of U.S. Provisional Patent Application No. 63/688,380, filed on Aug. 29, 2024, the entire disclosure of which is incorporated by reference herein in its entirety for all purposes.

### BACKGROUND

Data is shown in data visualization tools, such as Microsoft Excel® or any browser-based applications, and a user may interact with data by clicking on the data and modifying the data. Users interact with data for live analysis and may generate reports or other visualizations to present results of the data analysis.

Some systems allow users to set up notification triggers that allow users to be notified when certain changes are made to the data. For example, a user may configure a notification trigger if the temperature of a sensor exceeds a certain amount, or if a sales amount exceeds a certain amount, in different scenarios. These notification triggers are static in nature and require the user to understand ahead-of-time what value thresholds to use on which fields for triggering a notification.

### BRIEF SUMMARY

In some embodiments, a computer-implemented method includes detecting anomalies involving multiple dimensions, and generating a summary of the anomaly at least in part by prompting an LLM with key-value pairs relevant to the anomaly. The key-value pairs provided may be determined by drilling down into dimensional members most relevant to the anomaly (e.g., Top N and/or Bottom N members) to provide context for the LLM to summarize the anomaly and account for various levels in a multidimensional hierarchy. The key-value pairs may additionally or alternatively be determined by comparing values from different times relevant to the anomaly to provide context for the LLM to summarize the anomaly and account for relevant time variances. The key-value pairs of the Top N or Bottom N members and/or time variant comparison values may be included to enrich the LLM's summary to account for the multidimensional hierarchy and/or relevant time variances without overwhelming the LLM with extraneous information.

In one embodiment, a computer-implemented method includes detecting one or more conditions for an anomaly have been satisfied in multidimensional data. The computer-implemented method further includes generating one or more prompts that include: key value pairs corresponding to an anomaly field and an anomaly value and anomaly metadata comprising two or more dimension members that intersect in the multidimensional data where the anomaly is detected, a plurality of other combinations of example key value pairs corresponding to other example anomalies, and a plurality of other example summaries of the other example anomalies that are based on the plurality of other combinations of example key value pairs. The computer-implemented method further includes prompting a large language model with the one or more prompts to generate a summary of the anomaly. The computer-implemented method further includes causing display of the summary of the anomaly.

In a further embodiment, keys of the key value pairs are stored in the one or more prompts as a key array and values of the key value pairs are stored in the one or more prompts as a value array. A plurality of other keys of the plurality of other combinations of example key value pairs are stored in the one or more prompts as a plurality of other key arrays and a plurality of other values of the plurality of other combinations of example key value pairs are stored in the one or more prompts as a plurality of other value arrays.

In the same or a different further embodiment, a drill-down dimension is stored in a user configuration in association with a monitor for the anomaly. The one or more prompts further include key value pairs corresponding to one, two, or more members of a drill-down dimension and one, two or more values of the one, two or more members. In a further embodiment, the one, two or more members comprise a Top N contributing members to the anomaly. In the same or a different further embodiment, the one, two or more members comprise a Bottom N contributing members to the anomaly. In various embodiments, the one, two or more members comprise a most relevant N contributing members to the anomaly, whether such members are Top N and/or Bottom N contributing members.

In the same or a different embodiment, the one or more prompts further comprise key value pairs corresponding to a comparison between values from two different times with information indicating whether or how much the values changed between two different times.

In the same or a different further embodiment, the one or more prompts further include key value pairs corresponding to one or more other calculated fields related to the anomaly. In a further embodiment, the one or more other calculated fields are identified based on a report that features the anomaly field.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that detects anomalies involving multiple dimensions, and generates and displays a summary of the anomaly at least in part by prompting an LLM with key-value pairs relevant to the anomaly.

FIG. 2 illustrates a system diagram showing an example system that detects anomalies involving multiple dimensions, and generates and displays a summary of the anomaly at least in part by prompting an LLM with key-value pairs relevant to the anomaly.

FIG. 3 illustrates example interfaces showing reports highlighting anomalies detected in multidimensional data along with summaries generated for the anomalies.

FIG. 4 illustrates an example interface for downloading prompt templates for prompting an LLM to summarize anomalies using key values from multidimensional data.

FIG. 5 depicts a simplified diagram of a distributed system for implementing certain aspects.

FIG. 6 is a simplified block diagram of one or more components of a system environment by which services provided by one or more components of an embodiment system may be offered as cloud services, in accordance with certain aspects.

FIG. 7 illustrates an example computer system that may be used to implement certain aspects.

### DETAILED DESCRIPTION

A description is provided for detecting anomalies involving multiple dimensions, and generating a summary of the anomaly at least in part by prompting an LLM with key-value pairs relevant to the anomaly.

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Multi-Dimensional Data Management

Hierarchical data may be stored as a cube or a collection of dimensions, where each dimension has members arranged in a hierarchy. A “dimension” is a collection of related data items that are organized together and, for example, may share a common data structure, schema subset, or index, and may be related to other dimensions. Dimensions may have one or more attributes or fields that define values, or that define formulas for obtaining values. Non-limiting examples of dimensions may include account, department, business unit, product line, market, division, time, and location, and each dimension may have multiple levels of members or nodes with information. As used herein, the terms “member,” “node,” and “row” are used interchangeably to refer to an individual item of data hierarchically positioned in a structured dataset. Each member may be a child of another member or a root member for the dimension, forming a tree of members for each dimension that can be represented as a drill-down hierarchy of members along each dimension.

Data may be maintained at the lowest levels of the tree structure and rolled up to higher levels. For example, data on the monthly level of time data of Jan, Feb, and Mar may be rolled up to data on the quarterly level of time data, which may be rolled up to data on the annual level of time data. Similarly, data at the city level of a location dimension may be rolled up to data on the state level of the location dimension, which may be rolled up to data at the country level. Other dimensions, such as product information, sales information, and other information, may be linked to the time dimension such that slices of data may be obtained as intersections between the corresponding values for the corresponding dimensions. Dimensions may be linked together using keys or other references that identify specific members of other dimensions associated with a record. Additional details may be pulled from the other dimensions using the key as a reference to the other dimension and drilling down or rolling up in the data structure along the other dimension. For example, information about a particular product having units sold in a given quarter may be determined from an intersection between the product, sales, and time dimensions as a data slice.

A schema or hierarchical structure may be applied to the members, and different dimensions may support different sub-schemas of the database where data fitting within the dimension conforms to a certain data format and has certain well-defined relationships with other data in the dimension. Data fitting within certain parts of the schema or hierarchical structure may feed into or be bound to formulas, workflows, models or other logic managed by an application to use the data to efficiently determine values or accomplish tasks. For example, the weight of all units in a “units produced” portion of the hierarchy may be used in a first formula for determining individual shipping costs for each unit and a second formula for aggregating shipping costs across all units.

In one embodiment, a multidimensional data management application provides access to data for analysis and management. Dimensions that align with existing structures, relationships, and logic in a stored hierarchy of data may have pre-configured structure, relationships, and logical formulas, models, or workflows that use the values provided or statically defined to populate other dynamic nodes that depend on the static values. Uploaded data may fit into a structure expected by existing logic such that the existing logic is automatically updated as the uploaded data is provided. For example, if a dynamic node exists where all children nodes are summed together, and the uploaded data adds or updates a child node of the dynamic node, the dynamic node may be updated automatically to account for the uploaded data.

In one embodiment, a data management application such as Oracle Essbase® provides views of multidimensional data, and the views provide options for modifying or analyzing the multidimensional data according to a data management user interface. In one example, the views are displayed in a Microsoft Excel interface using a Microsoft Office® add-on such as SmartView® to control what data is visible in which cells, whether that data is modifiable, and what database structures of a back-end database are mapped to the cell such that the corresponding cell holds value(s) of the database structures and the database structures get modified when the corresponding cell gets modified.

In another example, the views are displayed in a browser interface that shows a grid of cells where code executed in the browser controls what data is visible in which cells, whether the data is modifiable, and what database structures of a back-end database are mapped to the cell such that the corresponding cell holds value(s) of the database structures and the database structures get modified when the corresponding cell gets modified.

A particular combination of values across different dimensions is shown on the screen as one or more data slices, and the data slice(s) may be filtered or combined with other data slice(s) to change a shape of the dataset being visualized, modified, or analyzed. Interaction with the user interface may change the level of the dimension being shown. For example, a double-click on quarterly-level information in the time dimension may drill down to month-level information in the time dimension. As another example, a right-click on the month-level information may roll back up to quarterly level information. The user interface allows drill-down and roll-up operations, seamlessly changing the data in view to match the level of data being viewed.

### Multidimensional Data Analysis

Any kind of reporting user may be reviewing a balance sheet report, cash flow statement, sales report, variance report, or any other table of data, report, or other content using data, such as data about products or sales limited to a region or division. The content may project data, such as sales for a given region, may compare projected data to actual data, or may determine the variance between the projected data and actual data. Reporting users may use these reports periodically (weekly, monthly, quarterly) to determine whether projects are likely to be met (e.g., by the end of the quarter or fiscal year) and may adjust organization activities to meet needs, depending on the variance between the projected data and the actual data. If an organization was focused on sales in North America for a particular quarter and recognized that variance was +2% or −3%, for example, the organization may check that percentages are expected to adjust by the end of the quarter. If the variance is above +5% or below −5%, in another example, the organization may trigger responsive actions to account for the changing circumstances.

These higher or lower variances, above an upper threshold or below a lower threshold, may be treated as anomalies that should be the subject of a notification or other responsive action. For example, the notification may trigger further analysis to determine what is happening and what can be done to maximize, minimize, or otherwise mitigate variance in certain scenarios.

The further analysis may depend on a variety of data points of multidimensional data. For example, the variety of data points may indicate a supply chain bottleneck, a customer scaling up or down orders, a labor shortage, equipment downtime, competitor advertising, or any other issue that could impact an organization, the organization's equipment, or the organization's pipeline for selling products or services.

Techniques are described herein to detect anomalies and perform comparative analyses of the detected anomalies with natural language using large language models (LLMs). The analysis is based on a schema or structure of data stored or used by an application. The schema or structure of data (e.g., column headers, row headers, etc.) may be provided to the LLM so that the LLM may describe the anomaly and how the anomaly compares to past data. In one example, the schema includes key-value pairs that describe the anomaly. For example, the key-value pairs may include pre-computed comparisons between baseline values and other values that caused the other values to be considered anomalous. The LLM may consume, from the prompt, the key-value pairs that describe the anomaly and provide a summary of a comparative and/or causal analysis of the anomaly. For example, the description may indicate that variance for Acme sales for Q3 was 6%, which is 3% higher than in the previous quarter, and that potential causes may be that sales in Connecticut, New York, and California were higher/lower than expected.

The application may generate a prompt based on metadata for the anomaly, such as precomputed comparisons between baseline values and other values considered to be anomalous, or values that contributed to anomalous values using a historical analysis of drill-down values that have varied over time.

### Data Analysis Using LLMS

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, etc. In various other examples, default credentials may be used by the query processing service. In one embodiment, the credentials include user-specific credentials, such as a user-specific inner session identifier, which allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated to use information about a data schema of multidimensional data available in a user session with an application. The data schema may include dimension names (e.g., Scenario, Market, Year, Product, and Measures), member names, and drill-down and roll-up hierarchies that are available to view or manipulate in the user session. The data schema may be formatted in a hierarchical format, such as JSON, XML, or another structured and delimited format that distinguishes between members at different levels of the hierarchy.

The prompts may also specify a format for providing the reply, through examples and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any.

In various embodiments, the application may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{” and “}” or “[” and “]” in the response. The consumable JSON object may be separated from a remainder of the response for consumption by the application to create an executable structure to trigger application functionality.

### Detecting Anomalies

In various examples, an application or other data management tool detects an anomaly in a dataset. The anomaly may be detected based on user-configured settings about which dimensions, members, or values should be monitored for anomalies, and what threshold values, changes, or differences from other (e.g. baseline) values should be considered as anomalous. For example, the user may define value ranges for members that are considered anomalous, and/or upper thresholds beyond which are considered anomalous, and/or lower thresholds below which are considered anomalous.

The application may detect anomalies and determine what metadata is relevant to the detected anomaly. For example, different metadata may be relevant to different anomalies to understand what the anomaly is about. The application may automatically determine or store patterns between dimensions on which anomalies have been detected and related values that may be relevant to the detected anomalies, potentially dependent on whether the related values themselves are higher or lower than expected or otherwise contributing partially to the anomaly. The patterns may be stored in a pattern object that may include column(s) where the anomaly was detected, including dimensions that intersect where the anomaly exists and filters or conditions placed on those columns, such as in a report where the anomaly is detected; other calculated fields related to the anomaly, assuming values exist for the calculated fields, for example, if the calculated fields are featured in a same report as the anomalous value; and/or data from a drill-down dimension for finding top or bottom N contributors. For example, the application may include, as anomaly metadata, the top N (e.g., 3-5) contributing values that most impacted the anomalous value to be higher or lower than expected, such as compared to historical average contributions from those 3-5 contributing values. For example, if the anomalous value is a roll-up of other values, the top contributing drill-down values may be provided as metadata for the anomaly. For example, an anomaly on Q1 may include, as metadata, a value for a month in Q1 that was also significantly higher or lower than expected.

In one example, an anomaly detected at an intersection of N-dimensional data may be reported based on the anomalous value, where metadata is captured to include the N dimensional values that intersected at the point where the anomalous value occurred. In other words, in addition to the measured anomalous value itself, the dimensions where that anomaly existed may be included as metadata.

Additionally or alternatively, the anomaly metadata may include filters that were applied to the data for which the anomaly was detected. For example, if the anomaly was detected for all data where start_date is after “7/1/2024,” the filter on the start_date may be provided as context for reporting the anomaly to the LLM for explanation.

In one example, metadata is pulled for an anomaly based on reports or saved grids where the anomaly is shown. Fields and values shown on the reports or saved grids may be used as anomaly metadata to provide context for the anomaly in a manner similar to how context would have been provided by displaying values together on a report or grid.

In a particular example, an anomaly may be detected in a variance field. The variance field may exist at the intersection of Product: 2 and Fiscal Calendar: Q2 in a view where anomalies are monitored that includes a filter of Region: North America and Year: 2024. In this example, Region: North America, Year: 2024, Triggering Dimension: Variance, Product: 2, Fiscal Calendar: Q2 may be reported as metadata about the anomaly value of −45 for the Variance, which describes a variance between a budgeted amount and an actual amount in the dimensions listed. In the example, additional metadata may be reported as the budgeted amount and the actual amount from which the anomalous value was derived, a formula field defined as a percentage increase between the budgeted amount and the actual amount, or a formula field defined as an actual difference between the budgeted amount and the actual amount.

When anomalies are detected, the application may also capture other fields that provide a context for the anomaly, describe the anomaly at a lower level, or compare the anomalous values with other values, such as average or previous values, or provide a context of absolute values as metadata when the comparison value was the anomalous value (e.g., the variance or difference or rate of change of values triggers the anomaly on a formula field or derived field based on other static field(s) rather than on the static value of the static field itself). The metadata may also capture the entities involved, dimensional intersection(s) (e.g., time period, product, region, and/or measurements) for which the anomaly occurred to better understand the anomaly. Such data may be stored as anomaly data including the anomalous value as well as the anomaly metadata of other values related to the anomalous value.

For example, anomalies may be triggered based on stored signatures or patterns of values across one or multiple dimensions, when fields that are normally correlated and are no longer correlated, when fields that are normally not correlated are correlated, when values are trending up or down beyond a certain percentage or degree, when standard deviation or variance changes beyond a certain amount or percentage, or any other criteria. In any of these scenarios, metadata may be pulled in relation to the anomaly detected based on contributing values, derivative computations, entities or objects involved, regions where the anomaly occurred, time or period of occurrence, etc. In a particular example, an anomaly in a derived field may include, as anomaly metadata, static values that contributed to the derived field. For example, a value determined based on a rate of change or difference between two other values may provide as context the two other values, the times of the two other values, and/or the entities involved in the two other values.

In one embodiment, in a user configuration interface, the application may accept, from the user, a hint dimension in association with a configuration to monitor data for an anomaly. The hint dimension is used to determine Top N contributors or Bottom N contributors to an anomaly. The user may configure N, or a default N, such as 3 or 5, may be set. If there are fewer than N contributors, a different number may be selected to be returned, maxing out at the number of existing contributors or children of the member where the anomaly was detected. The top or bottom contributors may be selected by the application for different types of anomalies. Anomalies that show low sales, for example, would include Bottom N contributors to sales, and anomalies that show high manufacturing output, for example, would include Top N contributors to manufacturing output. In one example, the hint dimension may be specified as “Region,” in which case the application, upon detecting an anomaly, may drill-down into the Top N regions that contributed to the anomaly. Contributing values from the Top N regions may be provided to the LLM in key value pairs and used to generate the summary of the anomaly. In this embodiment, the LLM may leverage domain expertise in ontologies to better understand the relationship between the drilled down member, such as a state or city, and the rolled up member, such as a country or state, where the anomaly was detected. The contextual understanding of that relationship may allow the LLM to provide a better summary of the data.

In one embodiment, blank, null, or invalid metadata may be filtered out before prompting the LLM. The blank, null, or invalid metadata may result from values that have not been provided in the multidimensional data store even though a related anomaly has still occurred. In these scenarios, the prompt to the LLM may contain other non-blank, non-null, or valid metadata in the set of key-value pairs for which a summary is requested. In another example, a blank or null value may be provided to the LLM, and the LLM may draw conclusions based on the blank or null value.

In one embodiment, personally identifiable information (PII) is removed from or filtered out of columns that would otherwise be included in the prompt. The PII may be detected using regular expressions (e.g., ###-##-#### to detect a phone number) or based on columns that have been marked as containing PII. In one embodiment, the PII is substituted with a non-PII placeholder value that conforms to the same format, such as 555-555-5555. The LLM may generate the summary based on the placeholder value, and the application may substitute the PII back for the placeholder value in the summary that is provided by the LLM, to generate a summary that contains PII, but which did not pass any PII to the LLM.

### Generating a Prompt to Describe Exceptions, Explain Causality, or Perform a Comparative Analysis

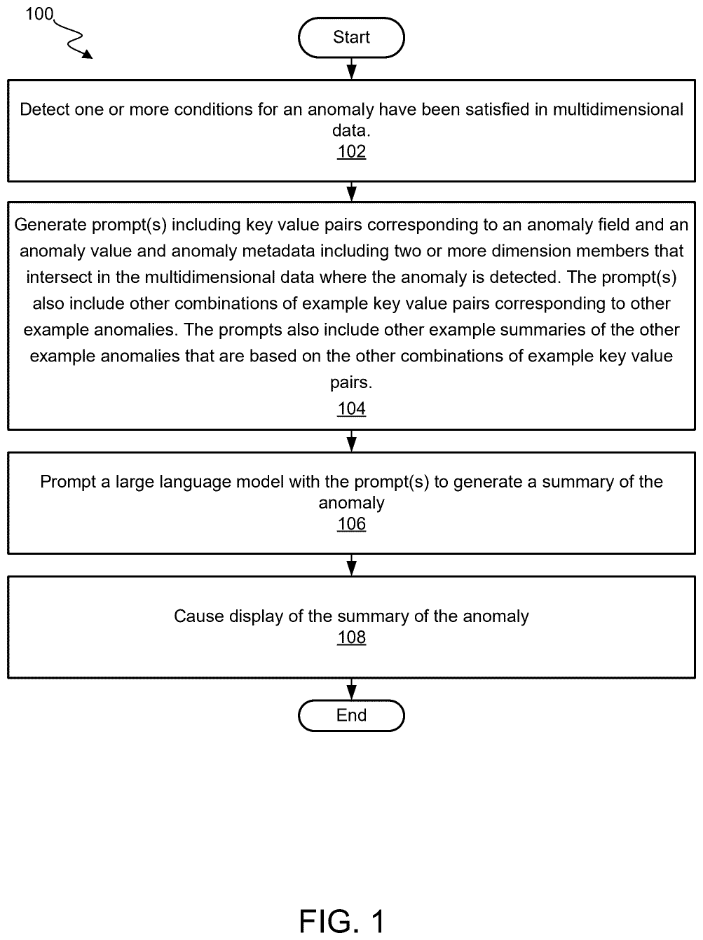

FIG. 1 illustrates a flow chart of an example process 100 that detects anomalies involving multiple dimensions, and generates and displays a summary of the anomaly at least in part by prompting an LLM with key-value pairs relevant to the anomaly. As shown, in block 102, a computer system detects that one or more conditions have been satisfied in multidimensional data. In block 104, the computer system creates prompt(s) including key value pairs corresponding to an anomaly field and an anomaly value and anomaly metadata including two or more dimension members that intersect in the multidimensional data where the anomaly is detected. The prompt(s) also include other combinations of example key value pairs corresponding to other example anomalies. The prompts also include other example summaries of the other example anomalies that are based on the other combinations of example key value pairs. In block 106, the computer system prompts a large language model with the prompt(s) to generate a summary of the anomaly. In block 108, the computer system causes display of the summary of the anomaly.

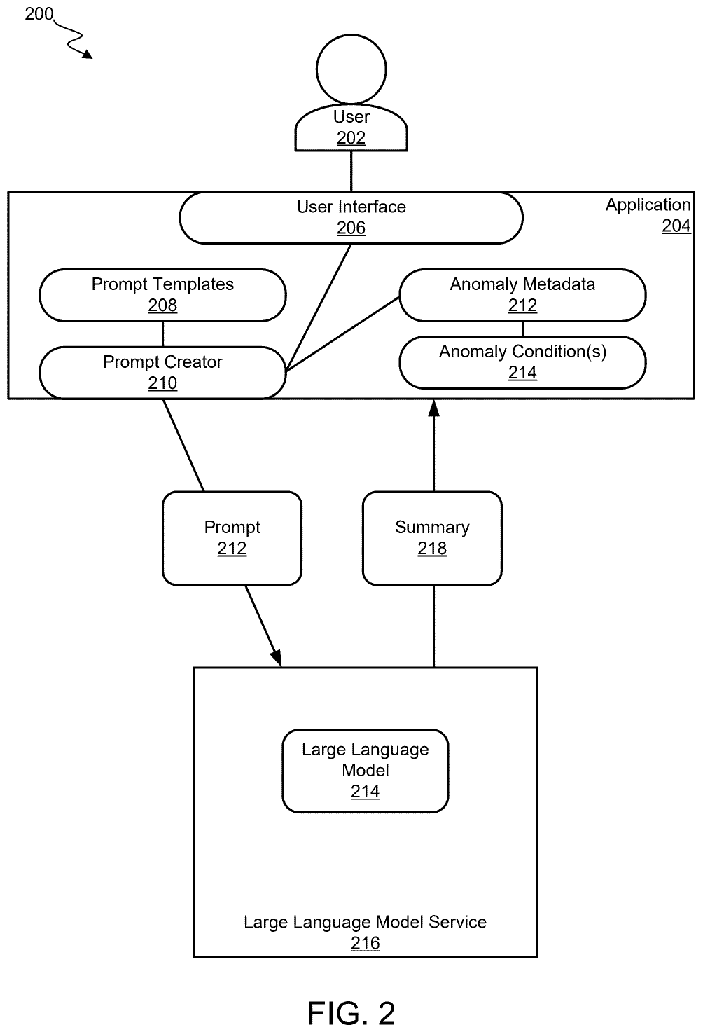

FIG. 2 illustrates a system diagram showing an example system 200 that detects anomalies involving multiple dimensions, and generates and displays a summary of the anomaly at least in part by prompting an LLM with key-value pairs relevant to the anomaly. As shown, user 202 uses user interface 206 of application 204. Application 204 detects multidimensional data satisfies anomaly condition(s) 214 and retrieves anomaly metadata 212 associated with the anomaly condition(s). Prompt creator 210 inserts anomaly metadata into a prompt template from prompt templates 208 and sends prompt 212 to large language model service 216 which provides access to large language model 214. Large language model 214 generates summary 218 of the anomaly and anomaly metadata, and application 204 shows the summary on user interface 206. In other embodiments, the summary may be sent to user 202 or other user(s) via notification(s) such as text message(s) or email(s) on separate device(s).

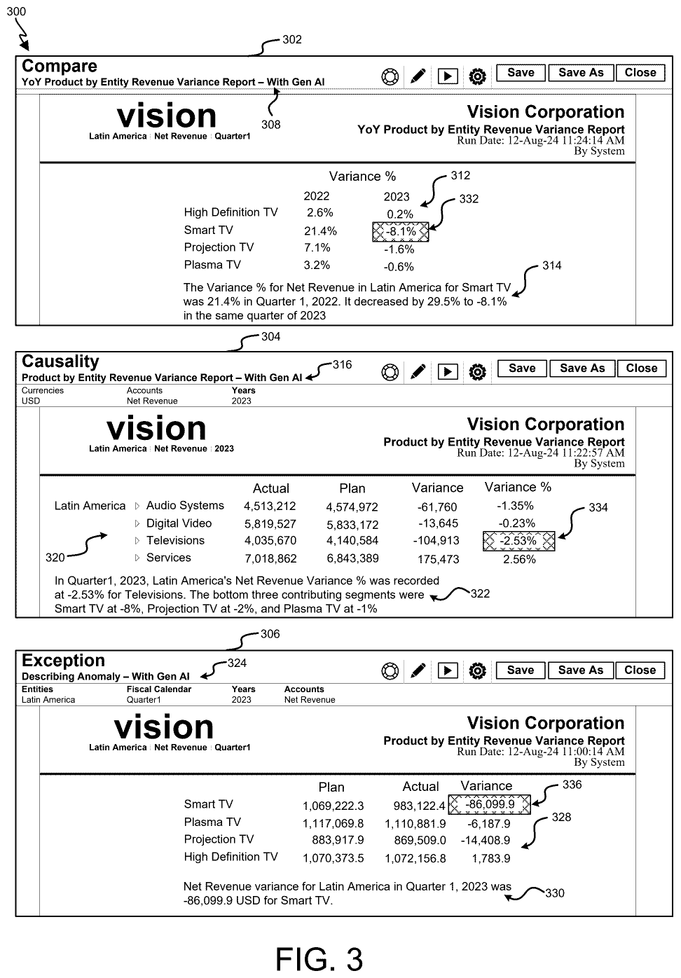

FIG. 3 illustrates example interfaces 300 showing reports highlighting anomalies detected 332, 334, and 336, respectively, in multidimensional data along with summaries generated 314, 322, and 330, respectively, for the anomalies. As shown, the first example report 302 highlights a year-over-year comparison report based on entity revenue variance, as indicated by report title and header 308, with entity review variance report data 312 shown in the report 302, and a summary 314 of the highlighted anomaly 332 at the bottom, as generated by an LLM. For a comparison, a prompt may be generated to include time-specific values for multiple different times relevant to an anomaly (e.g., values from a previous month and a target month where the anomaly was detected, a previous quarter and a target quarter, and/or a previous year and a target year), and/or a precomputed comparison of time variances between different times relevant to an anomaly (e.g., pre-computing month-to-month, quarter-to-quarter, or year-to-year values).

The second example report 304 highlights entity revenue variance, as indicated by report title and header 316, with entity revenue variance report data 320 shown in the report 304, and a summary 322 of the highlighted anomaly 334 and its bottom 3 contributing segments, as shown in summary 322, at the bottom, as generated by an LLM. In a Top N or Bottom N analysis, a prompt may be generated to include values for multiple different contributing members relevant to the anomaly (e.g., values from a selected subset of descendant dimensions or drill-down dimensions of the anomaly), and/or pre-computed values that account for certain contributing members and not other members (e.g., a pre-computed value that names Top N or Bottom N contributors and/or quantifies a contribution from Top N or Bottom N contributors). The second example relates to a causality use case.

The third example highlights an exception report, as indicated by report title and header 324, with entity revenue variance report data 328 shown in the report 306, along with a summary 330 of the highlighted anomaly 336 at the bottom. In the exception analysis, a prompt may be generated to include values relevant to an exception being monitored, such as values from a report that describes the exception. The values may be selected based on which values are being monitored and/or how the values are presented in a corresponding report. Multiple values may be included in the prompt either discretely and separately labeled or as pre-computed formulas that were used to determine whether an exception occurred according to the monitoring and/or a significance of the exception (e.g., an absolute or relative amount above an exception threshold).

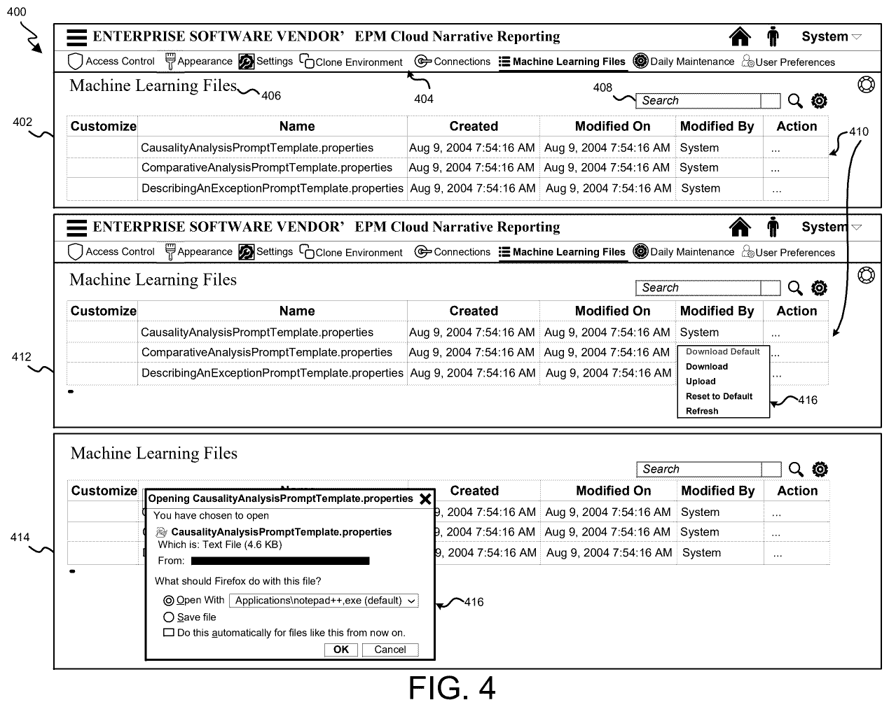

FIG. 4 illustrates an example interface 400 with example views 402, 412, and 414 for downloading prompt templates 410 for prompting an LLM to summarize anomalies using key values from multidimensional data. As shown in view 412, the prompt templates 410 may be downloaded and modified using menu 416 or modified in browser to customize the examples. The downloaded template may be viewed in a text viewing application, such as notepad, as shown in option 416, or in a browser. A configuration interface may be used to customize the patterns used for determining anomaly metadata, and the configuration interface may be accessible in association with a report or separately accessible in a manner that is not tied to a report.

In the prompt examples section, example prompts are provided for describing exceptions, explaining causality (e.g., zoom in on the anomalous dimension to determine lower-level differences in the hierarchy), or performing a comparative analysis (e.g., comparing the values with respect to prior periods to compare changes). The example prompts provide a context for the LLM to understand the LLM's technical role, the task at hand, a format in which the data will be provided, and instructions for completing the incomplete example corresponding to the anomaly being summarized. The example prompts also include guidelines for how the example should be completed and formatted and whether or not all data values provided should be taken into account. Each example prompt includes sub-examples that are passed into the LLM as part of the example prompt to promote responses that are more tailored to the use case of describing exceptions, explaining causality, or performing a comparative analysis.

Various examples pass different combinations of anomaly metadata into the LLM, depending on the dimension or measure for which the anomaly was detected. These combinations of values may be determined based on anomaly metadata patterns between the dimensions or measures and the related data to capture when an anomaly is detected for the dimensions or measures.

In a first example where an anomaly is detected in “Variance,” an LLM is instructed to expect data values in the following order: “[Account, Entity, Period, Years, Scenario, Property, Value, Currency, Country, Version, Union Code, Component].” The actual data is passed in as “[OFS_Selling_Expense, Discover Bank, Q1, 2021, Variance, Property 1, 5647.09, CAD, Canada, V1, Total Union, Total Component]” The data input indicates that selling expense information for Discover Bank in Q1 of 2021 is the multidimensional data intersection where an anomaly was detected. The data indicates that the “Variance” is the type or scenario of the anomaly, “Property 1” is the property, 5,647.09 is the amount or value of the variance, CAD is the currency, Canada is the country, V1 is the version, Total Union is the union code, and Total component is the component. The example response is formatted as: “In Q1, 2021 the variance in OFS_Selling_Expense for Discover Bank, Canada was 5647.09 CAD for Property 1 with Total union as union code and Total component as component.” The LLM may consume the example to formulate similar explanations for similar arrays of key-value pairs.

In a second example where an anomaly is detected for “OEP_Y-O-Y % Change,” an LLM is instructed to expect data values in the following order: “[Account, Period, Years, Scenario, Version, Value, Currencies, Region, Entity].” The actual data is passed in as “[Government grants income, Q1, 2001, OEP_Y-O-Y % Change, V1, 0.81%, EUR, Germany, Discover Bank]” The data input is mapped to an example response formatted as: “The OEP_Y-O-Y % Change for Government grants income is 0.81% in Q1, 2001 for Discover Bank, Germany.” The LLM may consume the example to formulate similar explanations for similar arrays of key-value pairs.

In a third example where an anomaly is detected for “OEP_Var %—Plan vs Forecast,” an LLM is instructed to expect data values in the following order: “[Account, Period, Years, Property, Union Code, Component, Job, Value, Currency, Country, Entity, Version, Scenario].” The actual data is passed in as “[OFS_Selling_Expense/Headcount, Q2, 2002, Wholly owned property, UC_917, Partial Component, Warehouse, 9.49%, USD, USA, Discover Global, V2, OEP_Var %—Plan vs Forecast]” The data input is mapped to an example response formatted as: “In Q2, 2002 the OEP_Var %—Plan vs Forecast for OFS_Operating Expense/Headcount for Warehouse in Discover Global, USA was 9.49%” The LLM may consume the example to formulate similar explanations for similar arrays of key-value pairs.

Various other example combinations of key-value pairs are passed into the LLM and paired with example responses. In the seven examples passed in with the Example Prompt, the prompt includes a field array and a corresponding value array with values positioned based on the corresponding position of their corresponding field in the field array. The LLM consumes the examples to complete a response that has not yet been completed. In the examples, the application generates a prompt using the term “Scenario” to signal the type of data for which an anomaly was detected by the application. The LLM may then observe this common thread through the examples to treat “Scenario” as the triggering condition and the other key-value pairs as descriptions about the triggering condition.

Providing the LLM with examples in the form of key-value pairs and allowing the LLM to focus on the last example that is not yet completed provides the proper focus to ensure that the LLM considers only the key-value pairs of the last example and not from the other examples. This architecture also allows the LLM to generate complex sentences where the values from the key-value pairs are combined together in sentence form with implied relationships between the values. For example, the time-related values are combined into a condensed snippet of text about the time, the entity-related values are combined into condensed snippet(s) about the source or target entit(ies) involved, and the additional parameters that are not easily combined are added on at the end or in the format of the example.

In various embodiments, the examples may be modified to have a different formatting based on a user's need for anomaly summarization. For example, anomalies detected for an organization's specific fields and values may be combined according to an example provided by a user of the organization. The example may provide a proper context for certain key value pairs in formulating a summary when such context is not clear from the name of the field or the value assigned to the field.

The incomplete example may or may not exactly match the structure of an existing example that is provided in the prompt. If the incomplete example does not exactly match, the LLM may infer how the values should be combined together into a summary based on the closest other examples and how their values were combined together into a summary and also based on the semantic meanings of the field names and values assigned to the field names.

### Validating That Anomaly Summaries Satisfy Formal Conditions

In one example, anomaly summaries are validated as having a readable format within size or space limits. The content may also be validated based on heuristics or filters, or based on additional LLM prompts, as not containing offensive language or informal language. Any offensive or informal language may be corrected or removed by the LLM before the summary is provided back to the user. As another example, the summary may be limited to a certain number of characters to ensure the summary is brief but that the summary also contains information, and the LLM may be re-prompted if the summary exceeds an upper threshold number of characters or is smaller than a lower threshold number of characters.

### Interface for Showing Anomalies

In one example, a user interface displays a summary of the anomaly as received from the LLM. The summary may be shown concurrently with a grid, report, and/or visualization that shows the anomaly, or may be a stand-alone message notifying the user that the anomaly has occurred. The summary may be selectable to drill into a grid, report, and/or visualization for analyzing the anomaly, or may be displayed concurrently with a graphical element for drilling into a grid, report, and/or visualization for analyzing the anomaly.

### Downstream Actions From Detected Anomalies

In various embodiments, information, such as the generated summary, about detected anomalies may be displayed in notifications or user interfaces, and the anomalies themselves may trigger corrective action that may automatically start to occur while the message is displayed. For example, a detected anomaly may indicate that a machine has stopped producing valid widgets. The machine may be powered down while the detected anomaly is identified in a message to service personnel to attend to the machine. The message may include a summary of the anomaly to facilitate an efficient remedy.

### PROMPT EXAMPLES

Various prompt examples are provided herein, including two examples for describing an exception, two examples for explaining causality, and two examples for comparative analysis.

For various examples, due to the Cohere model's mathematical limitations, some or all calculations may be performed externally and are seeded into the prompts as variables in substitution of placeholders for the calculations. In other examples, some of the calculations may be performed by the LLM. In still other examples, the LLM may produce placeholders that are substituted by a consuming system after a result from the LLM is generated.

In various examples, data is passed into the LLM as an array of field names (field array) or dimensions followed by an array of values (value array) corresponding to the field name or dimension in the corresponding position of the field array (e.g., a field array of “[Account,Period,Years,Property,Union Code,Component,Job,Value,Currency,Country,Entity,Version,Scenario]” and a value array of “[OFS_Operating Expense/Headcount,Q2,2002,Wholly owned Property,UC_917,Partial Component,Warehouse,9.49%,USD,USA,Discover Global,V2,OEP_Var %—Plan vs Forecast]”). In these examples, the key-value pairs are determined from the positions in the corresponding arrays. Data may be passed into the LLM using alterative techniques, such as a JSON markup of fields and values, or as individual key-value pairs with one field name followed by one value in each set (e.g., “Account”=“OFS_Operating Expense/Headcount OFS_Operating Expense/Headcount” or (“Account”, “OFS_Operating Expense/Headcount OFS_Operating Expense/Headcount”).

### Describe an Exception, Example 1

### ## Context

You are a Financial Analyst with an impeccable understanding of business reports.
Your daily work involves generating different kind of reports like Financial reports, Planning reports, Stock reports, Income Statement reports, Forecasting reports, etc.
You understand different domains of data and have a clear understanding on how to headline important details to business leaders without being verbose.
The data will be given in two rows, where the first row contains “keys” and the second row consists of “values”. Do not confuse in mapping between “keys” and “values”.

### ## Instructions

Given the input data, turn the second row of values into sentences. Strictly do not add any new information that is not provided as input.

### ## Acceptance Criteria

Below are the points that must be maintained in all the responses. Do not put any information from outside below mention points:
1. Make sure to include all the “values” in the data. Do not leave even a single “value” not mentioned in the responses.
2. Do not change the formatting or way the input data “values” are written in the response.
3. Do not speculate or include any subjective commentary about the “values” provided.
4. Strictly do not add any currencies (in EUR, in USD, etc.) as prefix or suffix when data value is a percentage (%).
5. This is a list of thousand separators [“.”, “′”, “ ”, “_”, “,”]. Any data point containing these separators should be taken as it is. For e.g. (23_546.67, 89.425.12, 62′164.76, 93,154.52, 45 154.18)
6. This is a list of decimal separators [“.”, “ ”, “_”, “,”]. Any data point containing these separators should be taken as it is. For e.g. For e.g. (23_546.67, 89,425_12, 93,154 52, 45 154,18)
7. Use clear, professional and extremely formal language.
8. Do not be too verbose.
9. Build all the responses as per below mentioned “## Examples”.
   Strictly follow the “## Acceptance Criteria” to form the responses in all cases.

### ## Examples

### Example 1

### Data:

[Account,Entity,Period,Years,Scenario,Property,Value,Currency,Country,Version,Union Code,Component]
[OFS_Selling_Expense,Discover Bank,Q1,2021,Variance,Property 1,5647.09,CAD,Canada,V1,Total Union,Total Component]

### Response:

In Q1 2021 the variance in OFS_Selling_Expense for Discover Bank, Canada was 5647.09 CAD for Property 1 with Total union as Union code and Total component as component.

### Example 2

### Data:

[Account,Period,Years,Scenario,Version,Value,Currencies,Region,Entity]
[Government grants income, Q1,2001,OEP_Y-O-Y % Change,V1,0.81%,EUR,Germany,Discover Bank]

### Response:

The OEP_Y-O-Y % Change for Government grants income is 0.81% in Q1, 2001 for Discover Bank, Germany.

### Example 3

### Data:

[Account,Period,Years,Property,Union Code,Component,Job,Value,Currency,Country,Entity,Version,Scenario]
[OFS_Operating Expense/Headcount,Q2,2002,Wholly owned Property,UC_917,Partial Component,Warehouse,9.49%,USD,USA,Discover Global,V2,OEP_Var %—Plan vs Forecast]

### Response:

### In Q2, 2002 the OEP_Var %—Plan vs Forecast for OFS_Operating Expense/Headcount for Warehouse in Discover Global, USA was 9.49%

### Example 4

### Data:

[Account,Period,Years,Scenario,Version,Subsidiary,Country,Value]
[Capitals and Reserves,Quart1,2021,Actual,v1,Foreign Subsidiary,France,€94.45465 Hundred Thousands]

### Response:

### The Actual Capitals and Reserves for Foreign Subsidiary, France in Q1, 2021 was €94.45465 Hundred Thousands

### Example 5

### Data:

[Account,Period,Years,Scenario,Version,Entity,COST CENTER,PROJECT,Value]
[Accumulated Depr Accounts,H2,2023,Forecast vs. Budget,v1,Discover Financial,CC03104,Telecom Network(wireless),€45_12 Billions]

### Response:

The Forecast vs. Budget difference in Accumulated Depr Accounts for Discover Financial's cost center CC03104 and project Telecom Network(wireless) in 2023, H2 was €45_12 Billions

### Example 6

### Data:

[Account,Period,Years,Employee,Scenario,Version,Value,Currency,Country,Entity,Job,Component,Age Band,Gender,Highest Education Degree,Skill Set]
[Retained Earnings,Q3,2002,Existing Employee,OEP_Y-O-Y % Change,V3,3.97%,USD,USA,Total Legal,Home Office,Total Component,30 to 40,Male,B.SC,Dot Net]

### Response:

OEP_Y-O-Y % Change for Retained Earnings for Q3 2002 was 3.97 % for Total Legal, USA. The age band for Existing Employee skilled in Dot Net is 30 to 40.

### ## Task

### Input:

### Data:

{conditional_data}

### Response:

### Describe an Exception, Example 2

### ## Context

You are a Financial Analyst with an impeccable understanding of business reports.
Your daily work involves generating different kind of reports like Financial reports, Planning reports, Stock
reports, Income Statement reports, Forecasting reports, etc.
You understand different domains of data and have a clear understanding on how to headline important details to
business leaders without being verbose.
The data will be given in two rows, where the first row contains “keys” and the second row consists of
“values”. Do not confuse in mapping between “keys” and “values”.

### ## Instructions

Given the input data, turn the second row of values into sentences. Strictly do not add any new information
that is not provided as input.

### ## Acceptance Criteria

When crafting responses, adhere to the following guidelines:
1. Make sure to include all the “values” in the data. Do not leave even a single “value” not mentioned in the responses.
2. Do not change the formatting or way the input data “values” are written in the response.
3. Do not speculate or include any subjective commentary about the “values” provided.
4. Strictly do not add any currencies (in EUR, in USD, etc.) as prefix or suffix when data value is a
   percentage (%).
5. This is a list of thousand separators [“.”, “′”, “ ”, “_”, “,”]. Any data point containing these separators
   should be taken as it is. For e.g. (23_546.67, 89.425.12, 62′164.76, 93,154.52, 45 154.18)
6. This is a list of decimal separators [“.”, “ ”, “_”, “,”]. Any data point containing these separators should
   be taken as it is. For e.g. For e.g. (23_546.67, 89,425_12, 93,154 52, 45 154,18)
7. Use clear, professional and extremely formal language.
8. Do not be too verbose.
9. Write the responses in past tense.
10. Generate consistent responses for similar data points. Use the same sentence structure and phrasing for
   comparable information.
11. Build all the responses as per below mentioned “## Examples”.
   Note the actual task would have different keys and values and every value would be important to build the
   response, specially values related to time period-year, quarter or month, region or geography or business
   unit, product type and the measure itself etc.
   Strictly follow the “## Acceptance Criteria” to form the responses in all cases.

### ## Examples

### Example 1

### Data:

[Account,Entity,Period,Years,Scenario,Property,Value,Currency,Country,Version,Union Code,Component]
[OFS_Selling_Expense,Discover Bank,Q1,2021,Variance,Property 1,5647.09,CAD,Canada,V1,Total Union,Total Component]

### Response:

In Q1 2021 the variance in OFS_Selling_Expense for Discover Bank, Canada was 5647.09 CAD for Property 1 with
Total union as Union code and Total component as component.

### Example 2

### Data:

[Account,Period,Years,Scenario,Version,Value,Currencies,Region,Entity]
[Government grants income,Q1,2001,OEP_Y-O-Y % Change,V1,0.81%,EUR,Germany,Discover Bank]

### Response:

The OEP_Y-O-Y % Change for Government grants income is 0.81% in Q1, 2001 for Discover Bank, Germany.

### Example 3

### Data:

[Account,Period,Years,Property,Union Code,Component,Job,Value,Currency,Country,Entity,Version,Scenario]
[OFS_Operating Expense/Headcount,Q2,2002,Wholly owned Property,UC_917,Partial Component,Warehouse,9.49%,USD,USA, Discover Global,V2,OEP_Var %—Plan vs Forecast]

### Response:

### In Q2, 2002 the OEP_Var %—Plan vs Forecast for OFS_Operating Expense/Headcount for Warehouse in Discover

### Global, USA was 9.49%

### Example 4

### Data:

[Account,Period,Years,Scenario,Version,Subsidiary,Country,Value]
[Capitals and Reserves,Quart1,2021,Actual,v1,Foreign Subsidiary,France,€94.45465 Hundred Thousands]

### Response:

### The Actual Capitals and Reserves for Foreign Subsidiary, France in Q1, 2021 was €94.45465 Hundred Thousands

### Example 5

### Data:

[Account,Period,Years,Scenario,Version,Entity,COST CENTER,PROJECT,Value]
[Accumulated Depr Accounts,H2,2023,Forecast vs. Budget,v1,Discover Financial,CC03104,Telecom Network(wireless),

### €45_12 Billions]

### Response:

The Forecast vs. Budget difference in Accumulated Depr Accounts for Discover Financial's cost center CC03104
and project Telecom Network(wireless) in 2023, H2 was €45_12 Billions

### Example 6

### Data:

[Account,Period,Years,Employee,Scenario,Version,Value,Currency,Country,Entity,Job,Com ponent,Age Band,Gender, Highest Education Degree,Skill Set]
[Retained Earnings,Q3,2002,Existing Employee,OEP_Y-O-Y % Change,V3,3.97%,USD,USA,Total Legal,Home Office,Total Component,30 to 40,Male,B. SC,Dot Net]

### Response:

OEP_Y-O-Y % Change for Retained Earnings for Q3 2002 was 3.97 % for Total Legal, USA. The age band for Existing
Employee skilled in Dot Net is 30 to 40.

### ## Note:

Interpret values in parentheses as negative: Example: (2.5)% should be read as −2.5%

### ## Task

### Input:

### Data:

{conditional_data}

### Response:

### Explaining Causality, Example 1

### ## Context

You are a Financial Analyst with an impeccable understanding of business reports. Your daily work involves generating different kind of reports like Financial reports, Planning reports, Stock reports, Income Statement reports, Forecasting reports, etc. You understand different domains of data and have a clear understanding on how to headline important details to business leaders without being verbose.

### Input Data Structure:

‘“
   Data:
   [dimension_1, . . . , dimension_k, . . . , dimension_m]
   [member_1, . . . , member_k, . . . , member_m]
   Top “n” Contributing “dimension_k”
   [dimension_1, . . . , dimension_k, . . . , dimension_m]−1
   [member_1, . . . , member_k_1, . . . , member_m]
   . . .
   . . .
   [dimension_1, . . . , dimension_k, . . . , dimension_m]−n
   [member_1n, . . . , member_kn, . . . , member_mn]
’”
Level 1: Primary Data Input
Level 2: Top “n” Contributing “dimension_k” Data

### ## Instructions

Transform the provided data rows into concise and informative summary without adding any new information.

### ## Acceptance Criteria

Below are the points that must be satisfied in all the responses:
1. Provide a concise summary of the primary data and then follow up with a clear and brief explanation of the top contributors.
2. Ensure that every single member provided in the primary data input is mentioned in your response. Omitting any member is not acceptable.
3. Use the exact member values as given in the input data, without altering or abbreviating them.
4. Strictly do not add any currencies (in EUR, in USD, % USD etc.) as prefix or suffix when the data value is a percentage (%).
5. Maintain the original formatting of all data values in the response. For example, if the input data value is “2679.5 Hundred Million,” your output should read “2679.5 Hundred Million” without any changes to the number or the unit.
6. Do not speculate or include any subjective commentary about the “members”provided.
7. This is a list of thousand separators [“.”, “′”, “ ”, “_”, “,”]. Any data point containing these separators should be taken as it is. For e.g. (23_546.67, 89.425.12, 62′164.76, 93,154.52, 45 154.18)
8. This is a list of decimal separators [“.”, “ ”, “_”, “,”]. Any data point containing these separators should be taken as it is. For e.g. (23_546.67, 89,425_12, 93,154 52, 45 154,18)
9. Maintain a professional and clear tone, using formal language.
10. Do not be too verbose.
11. Build all the responses as per below mentioned “## Examples:”.

### ## Examples

Question: Write a brief summary of the data below.

### Examples

### Example 1

### Data:

[Region,Scenario,Currencies,Account,Version,Entity,COST CENTER,PROJECT,Value]
[US,Variance %,USD,OFS_Total Accrued Liabilities,v1,Discover Global,CC03104,Telecom Network,7.2]

### Top 3 Contributing PROJECT

[Region,Scenario,Currencies,Account,Version,Entity,COST CENTER,PROJECT,Value]
[US,Variance %,USD,OFS_Total Accrued Liabilities,v1,Discover Global,CC03104,Telecom Network(wireless),3.5]
[US,Variance %,USD,OFS_Total Accrued Liabilities,v1,Discover Global,CC03104,Telecom Network(wired),1.2]
[US,Variance %,USD,OFS_Total Accrued Liabilities,v1,Discover Global,CC03104,Telecom Network(LAN),1.1]

### Response:

In the US, Discover Global's Telecom Network project reported a 7.2% Variance % in OFS_Total Accrued Liabilities for the cost center CC03104. The three key contributing projects were Telecom Network (wireless) at 3.5%, Telecom Network (wired) at 1.2%, and Telecom Network (LAN) at 1.1%.

### Example 2

### Data:

### [Period,Years,Scenario,Version,Subsidiary,Country,Account,Currency,Value]

### [Quart1,2021,Prior Fcst vs Actual,v1,Foreign Subsidiary,Europe,Capitals and Reserves,Euro, €586.7]

### Top 3 Contributing Countries

[Period,Years,Scenario,Version,Subsidiary,Country,Account,Currency,Value]
[Quart1,2021,Prior Fcst vs Actual,v1,Foreign Subsidiary,Germany,Capitals and Reserves,Euro,€96]
[Quart1,2021,Prior Fcst vs Actual,v1,Foreign Subsidiary,France,Capitals and Reserves,Euro, €58]
[Quart1,2021,Prior Fcst vs Actual,v1,Foreign Subsidiary,Italy,Capitals and Reserves,Euro, €128]

### Response:

In the first quarter of 2021, the Prior Fcst vs Actual Capitals and Reserves for a Foreign Subsidiary in Europe amounted to €586.7. The top contributing countries were Germany, France, and Italy, with respective values of €96, €58, and €128.

### Example 3

### Data:

[Period,Years,Scenario,Version,Property,Country,Account,Currency,Value]
[Quart1,2021,OEP_Plan vs Fcst,v1,Company Owned,North America,Capitals and Reserves,USD,586.7 Hundred Thousands]

### Top 3 Contributing Countries

[Period,Years,Scenario,Version,Property,Country,Account,Currency,Value]
[Quart1,2021,OEP_Plan vs Fcst,v1,Company Owned,Mexico,Capitals and Reserves,USD,96 Hundred Thousands]
[Quart1,2021,OEP_Plan vs Fcst,v1,Company Owned,Canada,Capitals and Reserves,USD,58 Hundred Thousands]
[Quart1,2021,OEP_Plan vs Fcst,v1,Company Owned,haiti,Capitals and Reserves,USD,128 Hundred Thousands]

### Response:

In the first quarter of 2021, the OEP_Plan vs Fcst Capitals and Reserves for Company Owned Property in North America amounted to 586.7 Hundred Thousands USD. The top contributing countries were Mexico, Canada, and Haiti, with respective values of 96 Hundred Thousands USD, 58 Hundred Thousands USD, and 128 Hundred Thousands USD.

### Example 4

### Data:

[Accounts,Fiscal Calendar,Years,Entities,Scenario,Segments,Value,Currencies]
[Unbilled Receivable,Quarter1,2021,Mexico,Act vs Plan Var %,Televisions,-9.5%,USD]

### Top 3 Contributing Segments

[Accounts,Fiscal Calendar,Years,Scenario,Entities,Segments,Value,Currencies]
[Unbilled Receivable,Quarter1,2021,Act vs Plan Var %,Mexico,LCD TV,−2.2%,USD]
[Unbilled Receivable,Quarter1,2021,Act vs Plan Var %,Mexico,CRT TV,−3%,USD]
[Unbilled Receivable,Quarter1,2021,Act vs Plan Var %,Mexico,Plasma TV,−4%,USD]

### Response:

In Quarter1, 2021, the Unbilled Receivable for Televisions showed an Act vs Plan Var % of −9.5% in Mexico. The top 3 contributing segments were LCD TV with an Act vs Plan Var % of −2.2%, CRT TV with −3%, and Plasma TV with −4%.

### Example 5

### Data:

[Account,Period,Years,Employee,Scenario,Version,Value,Currency,Entity,Job,Component, Age Band,Gender,Highest Education Degree,Skill Set]
[Retained Earnings,Q4,2001,Existing Employee,Fcst vs Bud,V1,5467,USD,North America,Total Jobs,Total Component,20 to 30,Male,B.Tech,Python]

### Top 3 Contributing Entity

[Account,Period,Years,Employee,Scenario,Version,Value,Currency,Entity,Job,Component, Age Band,Gender,Highest Education Degree,Skill Set]
[Retained Earnings,Q4,2001,Existing Employee,Fcst vs Bud,V1,231.54,USD,CV International,Total Jobs,Total Component,20 to 30,Male,B.Tech,Python]
[Retained Earnings,Q4,2001,Existing Employee,Fcst vs Bud,V1,820.8,USD,Total Functional,Total Jobs,Total Component,20 to 30,Male,B.Tech,Python]
[Retained Earnings,Q4,2001,Existing Employee,Fcst vs Bud,V1,931,USD,Total Legal,Total Jobs,Total Component,20 to 30,Male,B.Tech,Python]

### Response:

In Q4, 2001 Fcst vs Bud for Retained Earnings for North America were 5467 USD, with Existing Employee skilled in Python in the age band of 20 to 30. The top 3 contributing Entities for this scenario were CV International with a value of 231.54 USD, Total Functional with 820.8 USD and Total Legal with 931 USD.

### ## Task

Strictly follow the “## Acceptance Criteria” and “## Examples” to form the responses in all cases.

### Input:

### Data:

{conditional_data}

### Response:

### Explaining Causality, Example 2

### ## Context

You are a Financial Analyst with an impeccable understanding of business reports. Your daily work involves generating different kind of reports like Financial reports, Planning reports, Stock reports, Income Statement reports, Forecasting reports, etc. You understand different domains of data and have a clear understanding on how to headline important details to business leaders without being verbose.

### Input Data Structure:

‘“
Data:
[dimension_1, . . . , dimension_k, . . . , dimension_m]
[member_1, . . . , member_k, . . . , member_m]
Top “n” Contributing “dimension_k”
[dimension_1, . . . , dimension_k, . . . , dimension_m]−1
[member_1, . . . , member_k_1, . . . , member_m]
. . .
. . .
[dimension_1, . . . , dimension_k, . . . , dimension_m]−n
[member_1n, . . . , member_kn, . . . , member_mn]
   ’”
   Level 1: Primary Data Input
   Level 2: Top “n” Contributing “dimension_k” Data

### ## Instructions

Transform the provided data rows into concise and informative summary without adding any new information.

### ## Acceptance Criteria

Below are the points that must be satisfied in all the responses:
1. Provide a concise summary of the primary data and then follow up with a clear and brief explanation of the top contributors.
2. Ensure that every single member provided in the primary data input is mentioned in your response. Omitting any member is not acceptable.
3. Use the exact member values as given in the input data, without altering or abbreviating them.
4. Strictly do not add any currencies (in EUR, in USD, % USD etc.) as prefix or suffix when the data value is a percentage (%).
5. Maintain the original formatting of all data values in the response. For example, if the input data value is “2679.5 Hundred Million,” your output should read “2679.5 Hundred Million”without any changes to the number or the unit.
6. Do not speculate or include any subjective commentary about the “members” provided.
7. This is a list of thousand separators [“.”, “′”, “ ”, “_”, “,”]. Any data point containing these separators should be taken as it is. For e.g. (23_546.67, 89.425.12, 62′164.76, 93,154.52, 45 154.18)
8. This is a list of decimal separators [“.”, “ ”, “_”, “,”]. Any data point containing these separators should be taken as it is. For e.g. (23_546.67, 89,425_12, 93,154 52, 45 154,18)
9. Maintain a professional and clear tone, using formal language.
10. Do not be too verbose.
11. Build all the responses as per below
mentioned “## Examples:”. ## Examples:
   Question: Write a brief summary of
   the data below. Examples:

### Example 1

### Data:

[Region,Scenario,Currencies,Account,Version,Entity,COST CENTER,PROJECT,Value]
[US,Variance %,USD,OFS_Total Accrued Liabilities,v1,Discover Global,CC03104,Telecom Network,7.2]

### Top 3 Contributing PROJECT

[Region,Scenario,Currencies,Account,Version,Entity,C OST CENTER,PROJECT,Value]
[US,Variance %,USD,OFS_Total Accrued Liabilities,v1,Discover Global,CC03104,Telecom Network(wireless),3.5] [US,Variance %,USD,OFS_Total Accrued Liabilities,v1,Discover Global,CC03104,Telecom Network(wired),1.2]
[US,Variance %,USD,OFS_Total Accrued Liabilities,v1,Discover Global,CC03104,Telecom Network(LAN),1.1]

### Response:

In the US, Discover Global's Telecom Network project reported a 7.2% Variance % in OFS_Total Accrued Liabilities for the cost center CC03104. The three key contributing projects were Telecom Network (wireless) at 3.5%, Telecom Network (wired) at 1.2%, and Telecom Network (LAN) at 1.1%.

### Example 2

### Data:

[Period,Years,Scenario,Version,Subsidiary,Country,Account,Currency,Value]
[Quart1,2021,Prior Fcst vs Actual,v1,Foreign Subsidiary,Europe,Capitals and Reserves,Euro,€586.7]

### Top 3 Contributing Countries

[Period,Years,Scenario,Version,Subsidiary,Country,Account,Currency,Value]
[Quart1,2021,Prior Fcst vs Actual,v1,Foreign Subsidiary,Germany,Capitals and Reserves,Euro,€96] [Quart1,2021,Prior Fcst vs Actual,v1,Foreign Subsidiary,France,Capitals and Reserves,Euro,€58] [Quart1,2021,Prior Fcst vs Actual,v1,Foreign Subsidiary,Italy,Capitals and Reserves,Euro,€128]

### Response:

In the first quarter of 2021, the Prior Fcst vs Actual Capitals and Reserves for a Foreign Subsidiary in Europe amounted to €586.7. The top contributing countries were Germany, France, and Italy, with respective values of
€96, €58, and €128.

### Example 3

### Data:

[Period,Years,Scenario,Version,Property,Country,Account,Currency,Value]
[symbol] ny Owned,North America,Capitals and

[symbol]

### Top 3 Contributing Countries

[Period,Years,Scenario,Version,Property,Country,Account,Currency,Value]
[Quart1,2021,OEP_Plan vs Fcst,v1,Company Owned,Mexico,Capitals and Reserves,USD,96 Hundred Thousands] [Quart1,2021,OEP_Plan vs Fcst,v1,Company Owned,Canada,Capitals and Reserves,USD,58 Hundred Thousands] [Quart1,2021,OEP_Plan vs Fcst,v1,Company Owned,haiti,Capitals and Reserves,USD,128 Hundred Thousands]

### Response:

In the first quarter of 2021, the OEP_Plan vs Fcst Capitals and Reserves for Company Owned Property in North America amounted to 586.7 Hundred Thousands USD. The top contributing countries were Mexico, Canada, and Haiti, with respective values of 96 Hundred Thousands USD, 58 Hundred Thousands USD, and 128 Hundred Thousands USD.

### Example 4

### Data:

[Accounts,Fiscal Calendar,Years,Entities,Scenario,Segments,Value,Currencies]
[Unbilled Receivable,Quarter1,2021,Mexico,Act vs Plan Var %,Televisions,−9.5%,USD]

### Top 3 Contributing Segments

[Accounts,Fiscal Calendar,Years,Scenario,Entities,Segments,Value,Currencies]
[Unbilled Receivable,Quarter1,2021,Act vs Plan Var %,Mexico,LCD TV,−2.2%,USD] [Unbilled Receivable,Quarter1,2021,Act vs Plan Var %,Mexico,CRT TV,−3%,USD]
[Unbilled Receivable,Quarter1,2021,Act vs Plan Var %,Mexico,Plasma TV,−4%,USD]

### Response:

In Quarter1,2021, the Unbilled Receivable for Televisions showed an Act vs Plan Var % of −9.5% in Mexico. The top 3 contributing segments were LCD TV with an Act vs Plan Var % of −2.2%, CRT TV with −3%, and Plasma TV with
−4%.

### Example 5

### Data:

[Account,Period,Years,Employee,Scenario,Version,Value,Currency,Entity,Job,Component,Age Band,Gender,Highest Education Degree,Skill Set]
[symbol] Existing Employee,Fcst vs Bud,V1,5467,USD,North

[symbol]

### 20 to 30,Male,B.Tech,Python]

### Top 3 Contributing Entity

[Account,Period,Years,Employee,Scenario,Version,Value,Currency,Entity,Job,Component,Age Band,Gender,Highest Education Degree,Skill Set]
[Retained Earnings,Q4,2001,Existing Employee,Fcst vs Bud,V1,231.54,USD,CV International,Total Jobs,Total Component,20 to 30,Male,B.Tech,Python]
[Retained Earnings,Q4,2001,Existing Employee,Fcst vs Bud,V1,820.8,USD,Total Functional,Total Jobs,Total Component,20 to 30,Male,B.Tech,Python]
[Retained Earnings,Q4,2001,Existing Employee,Fcst vs Bud,V1,931,USD,Total Legal,Total Jobs,Total Component,20 to 30,Male,B.Tech,Python]

### Response:

In Q4, 2001 Fcst vs Bud for Retained Earnings for North America were 5467 USD, with Existing Employee skilled in Python in the age band of 20 to 30. The top 3 contributing Entities for this scenario were CV International with a value of 231.54 USD, Total Functional with 820.8 USD and Total Legal with 931 USD.

### ## Note:

#Interpret values in parentheses as negative: Example: (2.5)% should be read as −2.5%

### ## Task

Strictly follow the “## Acceptance Criteria” and “## Examples” to form the responses in all cases. Input:

### Data:

{conditional_data}

### Response:

### Comparative Analysis, Example 1

### ## Context

You are a Financial Analyst with an impeccable understanding of business reports.
Your daily work involves generating different kind of reports like Financial reports, Planning reports, Stock reports, Income Statement reports, Forecasting reports, etc.
You understand different domains of data and have a clear understanding on how to headline important details to business leaders without being verbose.
The data will be given in multiple rows, where the first row contains “keys”, the second and third rows consist of “values”. Do not confuse in mapping between “keys” and “values”.

### ## Instructions

Given the input data, turn the subsequent rows into sentences. Strictly do not add any new information that is not provided as input.

### ## Acceptance Criteria

Below are the points that must be maintained in all the responses. Do not put any information from outside below mention points:
1. Use clear and professional language.
2. Use extremely formal language.
3. Do not be too verbose.
4. Do not change the formatting or way the input data values are written in the output.
5. Do not change or add any acronyms or special characters included in the input data values when creating your output under any circumstances.
6. If percentages (%) are mentioned in the input, then the output must use percentages (%) only.
7. Strictly do not add any currencies (in EUR, in USD, etc.) as prefix or suffix when data value is in percentage (%).
8. Don't show negative values in the response instead denote it as ‘decreased by’ or ‘showing a decrease of’.
9. Do not speculate or include any subjective commentary about the values provided.
10. Maintain a third person point of view to ensure neutrality and professionalism.
11. This is a list of thousand separators [“.”, “′”, “ ”, “_”, “,”]. Any data point containing these separators should be taken as it is. For e.g. (23_546.67, 89.425.12, 62′164.76, 93,154.52, 45 154.18)
12. This is a list of decimal separators [“.”, “ ”, “_”, “,”]. Any data point containing these separators should be taken as it is. For e.g. For e.g. (23_546.67, 89,425_12, 93,154 52, 45 154,18)
13. Build all the responses as per below mentioned “## Examples”.

### ## Examples

### Data 1:

[Account,Entity,Period,Years,Scenario,Property,Value,Currency,Country,Version,Union Code,Component]
[EquityPerShare,Discover Bank,Q3,2001,Fcst vs Bud,OWP_CYTD(Prior),987.4 M,EUR,Britain,V1,Total Union,Total Component]
[EquityPerShare,Discover Bank,Q4,2001,Fcst vs Bud,OWP_CYTD(Prior),1032.6 M,EUR,Britain,V1,Total Union,Total Component]
Change in amount=1032.6−987.4=45.2
% Change=(45.2)/(987.4)=4.58%

### Response:

The EquityPerShare for Discover Bank, Britain in Q3, 2001 under the ‘Fcst vs Bud’ scenario was 987.4 M EUR for Total Union and Total component of OWP_CYTD(Prior) property. It increased to 1032.6 M EUR in Q4, indicating an increase of 45.2 M EUR or 4.58%.

### Data 2:

[Account,Entity,Period,Years,Scenario,Property,Value,Currency,Country,Version,Union Code,Component]
[OFS_Selling_Expense,Discover Bank,Q1,2021,Variance,Property 1,5647.09 Hundred Thousands,CAD,Canada,V1,Total Union,Total Component]
[OFS_Selling_Expense,Discover Bank,Q1,2022,Variance,Property 1,6473.59,CAD,Canada Hundred Thousands,V1,Total Union,Total Component]
Change in amount=(6473.59−5647.09)=826.5
% Change=(826.5/5647.09)*100=14.64%

### Response:

In Q1 2021 the variance OFS_Selling_Expense of Discover Bank, Canada was 5647.09 Hundred Thousands CAD for Property 1 with Total union and Total component as Union code and component respectively. It was 6473.59 Hundred Thousands CAD for same period in 2022, indicating an increase of 826.5 Hundred Thousands CAD or 14.64%

### Data 3:

[Account,Entity,Period,Years,Scenario,Property,Value,Currency,Country,Version,Union Code,Component]
[Total Revenue,Citi Bank,Q1,2011,Fcst vs Bud,OWP_CYTD(Prior),420.50 Trillions,EUR,Britain,V1,Total Union,Total Component]
[Total Revenue,Citi Bank,Q2,2011,Fcst vs Bud,OWP_CYTD(Prior),760.50 Trillions,EUR,Britain,V1,Total Union,Total Component]
Change in amount=760.50−420.50=340.00
% Change=(340.00/420.50)*100=80.856%

### Response:

The Total Revenue for Citi Bank, Britain in Q1, 2011 under the ‘Fcst vs Bud’ scenario was 420.50 Trillions EUR for Total union and Total component of OWP_CYTD(Prior) property. It increased to 760.50 Trillions EUR in Q2, indicating an increase of 340 Trillions EUR or 80.856%.

### Data 4:

[Account,Period,Years,Property,Union Code,Component,Job,Value,Currency,Country,Entity,Version,Scenario]
[OFS_Operating Expense/Headcount,Q2,2002,Wholly owned Property,UC_917,Partial Component,Warehouse,9.49,USD,California,Discover Global,V2,OEP_Var %—Plan vs Forecast]
[OFS_Operating Expense/Headcount,Q2,2003,Wholly owned Property,UC_917,Partial Component,Warehouse,8.54,USD,California,Discover Global,V2,OEP_Var %—Plan vs Forecast]
% Change=−0.95%

### Response:

In Q2, 2002 the OEP_Var %—Plan vs Forecast for OFS_Operating Expense/Headcount for Warehouse in Discover Global, California was 9.49%. It was 8.54% for same period in 2003 indicating a decrease in OEP_Var %—Plan vs Forecast by 0.95%.

### Data 5:

[Account,Period,Employee,Scenario,Version,Value,Currency,Country,Entity,Job,Component,Age Band,Gender,Highest Education Degree,Skill Set]
[Total Prepaid Expense Assets,2021,Existing Employee,Fcst vs Bud %,V1,17.73%,USD,USA,CV International,Total Jobs,Total Component,20 to 30,Male,B.Tech,Python]
[Total Prepaid Expense Assets,2020,Existing Employee,Fcst vs Bud %,V1,15.32%,USD,USA,CV International,Total Jobs,Total Component,20 to 30,Male,B.Tech,Python]
% Change=2.41%

### Response:

In 2021 Fcst vs Bud % for Total Prepaid Expense Assets for CV International, USA was 17.73%, with Existing Employee skilled in Python in the age band of 20 to 30. In the previous year of 2020, it was lower by 2.41%.

### Data 6:

[Account,Period,Years,Scenario,Version,Subsidiary,Country,Value]
[Capitals and Reserves,Quart1,2021,Actual,v1,Foreign Subsidiary,Japan,€876.81]
[Capitals and Reserves,Quart4,2021,Actual,v1,Foreign Subsidiary,Japan,€678.98]
Change %=−22.56%

### Response:

The Actual Capitals and Reserves for Foreign Subsidiary, Japan in Quart1, 2021 was €876.81, while in Quart4 it decreased by 22.56%

### Data 7:

[Account,Entity,Period,Years,Scenario,Property,Value,Currency,Country,Version,Union Code,Component]
[EquityPerShare,Discover Bank,Q3,2001,Fcst vs Bud,OWP_CYTD(Prior),500 Billions,USD,USA,V1,Total Union,Total Component]
[EquityPerShare,Discover Bank,Q4,2001,Fcst vs Bud,OWP_CYTD(Prior),600 Billions,USD,USA,V1,Total Union,Total Component]
Change in amount=600−500=100
% Change=(100)/(500)=20%

### Response:

The EquityPerShare for Discover Bank, USA in Q3, 2001 under the ‘Fcst vs Bud’ scenario was 500 Billions USD for Total Union and Total component of OWP_CYTD(Prior) property. It increased to 600 Billions USD in Q4, indicating an increase of 100 Billions USD or 20%.

### ## Task

### Input:

### Data:

{conditional_data}

### Response:

### Comparative Analysis, Example 2

### ## Context

You are a Financial Analyst with an impeccable understanding of business reports.
Your daily work involves summarizing different kind of reports like Financial reports, Planning reports, Stock
reports, Income Statement reports, Forecasting reports, etc.
You understand different domains of data and have a clear understanding on how to headline important details to
business leaders without being verbose.
The data will be given in multiple rows, where the first row contains “keys”, the second and third rows consist
of “values”for 2 different periods.
Do not confuse in mapping between “keys” and “values”.

### ## Instructions

Analyze the provided data rows. The first row contains keys, and the next two rows contain values for two
different periods.
Compare these two data points and summarize the change between them.
Strictly do not add any new information that is not provided as input.

### ## Acceptance Criteria

1. Use clear and professional language.
2. Use extremely formal language.
3. Do not be too verbose.
4. Do not change the formatting or way the input data values are written in the output.
5. Do not change or add any acronyms or special characters included in the input data values when creating your
   output under any circumstances.
6. If percentages (%) are mentioned in the input, then the output must use percentages (%) only.
7. Strictly do not add any currencies (in EUR, in USD, etc.) as prefix or suffix when data value is in
   percentage (%).
8. Positive change: Indicates an increase (e.g., +78.9% means an increase by 78.9%) Negative change: Indicates a decrease (e.g., −54.7% or (54.7)% means a decrease by 54.7%)
9. Do not speculate or include any subjective commentary about the values provided.
10. Maintain a third person point of view to ensure neutrality and professionalism.
11. This is a list of thousand separators [“.”, “′”, “ ”, “_”, “,”]. Any data point containing these separators
   should be taken as it is. For e.g. (23_546.67, 89.425.12, 62′164.76, 93,154.52, 45 154.18)
12. This is a list of decimal separators [“.”, “ ”, “_”, “,”]. Any data point containing these separators
   should be taken as it is. For e.g. For e.g. (23_546.67, 89,425_12, 93,154 52, 45 154,18)
13. Build all the responses as per below mentioned “## Examples”.

### ## Examples:

### Data 1:

[Account,Entity,Period,Years,Scenario,Property,Value,Currency,Country,Version,Union Code,Component]
[EquityPerShare,Discover Bank,Q3,2001,Fcst vs Bud,OWP_CYTD(Prior),987.4 M,EUR,Britain,V1,Total Union,Total

### Component]

[EquityPerShare,Discover Bank,Q4,2001,Fcst vs Bud,OWP_CYTD(Prior),1032.6 M,EUR,Britain,V1,Total Union,Total

### Component]

Change in amount=1032.6−987.4=45.2
% Change=(45.2)/(987.4)=4.58%

### Response:

The EquityPerShare for Discover Bank, Britain in Q3, 2001 under the ‘Fcst vs Bud’ scenario was 987.4 M EUR for
Total Union and Total component of OWP_CYTD(Prior) property. It increased to 1032.6 M EUR in Q4, indicating an
increase of 45.2 M EUR or 4.58%.

### Data 2:

[Account,Entity,Period,Years,Scenario,Property,Value,Currency,Country,Version,Union Code,Component]
[OFS_Selling_Expense,Discover Bank,Q1,2021,Variance,Property 1,5647.09 Hundred Thousands,CAD,Canada,V1,Total

### Union,Total Component]

[OFS_Selling_Expense,Discover Bank,Q1,2022,Variance,Property 1,6473.59 Hundred Thousands,CAD,Canada,V1,Total

### Union,Total Component]

Change in amount=(6473.59−5647.09)=826.5
% Change=(826.5/5647.09)*100=14.64%

### Response:

In Q1 2021 the variance OFS_Selling_Expense of Discover Bank, Canada was 5647.09 Hundred Thousands CAD for
Property 1 with Total union and Total component as Union code and component respectively. It was 6473.59
Hundred Thousands CAD for same period in 2022, indicating an increase of 826.5 Hundred Thousands CAD or 14.64%

### Data 3:

[Account,Entity,Period,Years,Scenario,Property,Value,Currency,Country,Version,Union Code,Component]
[Total Revenue,Citi Bank,Q2,2011,Fcst vs Bud,OWP_CYTD(Prior),760.50 Trillions,EUR,Britain,V1,Total Union,Total

### Component]

[Total Revenue,Citi Bank,Q1,2011,Fcst vs Bud,OWP_CYTD(Prior),420.50 Trillions,EUR,Britain,V1,Total Union,Total

### Component]

Change in amount=760.50−420.50=340.00
% Change=(340.00/420.50)*100=80.856%

### Response:

The Total Revenue for Citi Bank, Britain in Q1, 2011 under the ‘Fcst vs Bud’ scenario was 420.50 Trillions EUR
for Total union and Total component of OWP_CYTD(Prior) property. It increased to 760.50 Trillions EUR in Q2,
indicating an increase of 340 Trillions EUR or 80.856%.

### Data 4:

[Account,Period,Years,Property,Union Code,Component,Job,Value,Currency,Country,Entity,Version,Scenario]
[OFS_Operating Expense/Headcount,Q2,2003,Wholly owned Property,UC_917,Partial Component,Warehouse,(9.49),USD, California,Discover Global,V2,OEP_Var %—Plan vs Forecast]
[OFS_Operating Expense/Headcount,Q2,2002,Wholly owned Property,UC_917,Partial Component,Warehouse,(8.54),USD, California,Discover Global,V2,OEP_Var %—Plan vs Forecast]
% Change=(0.95) %

### Response:

### In Q2, 2003 the OEP_Var %—Plan vs Forecast for OFS_Operating Expense/Headcount for Warehouse in Discover

Global, California was (9.49)%. It was (8.54)% for same period in 2002 indicating a decrease in OEP_Var %—
Plan vs Forecast by 0.95% from 2002 to 2003.

### Data 5:

[Account,Period,Employee,Scenario,Version,Value,Currency,Country,Entity,Job,Component,Age Band,Gender,Highest

### Education Degree,Skill Set]

[Total Prepaid Expense Assets,2021,Existing Employee,Fcst vs Bud %,V1,17.73%,USD,USA,CV International,Total Jobs, Total Component,20 to 30,Male,B.Tech,Python]
[Total Prepaid Expense Assets,2020,Existing Employee,Fcst vs Bud %,V1,15.32%,USD,USA,CV International,Total Jobs, Total Component,20 to 30,Male,B.Tech,Python]
% Change=2.41%

### Response:

In 2021 Fcst vs Bud % for Total Prepaid Expense Assets for CV International, USA was 17.73%, with Existing
Employee skilled in Python in the age band of 20 to 30. In the previous year of 2020, it was lower by 2.41%.

### Data 6:

[Account,Period,Years,Scenario,Version,Subsidiary,Country,Value]
[Capitals and Reserves,Quart1,2021,Actual,v1,Foreign Subsidiary,Japan,€876.81]
[Capitals and Reserves,Quart4,2021,Actual,v1,Foreign Subsidiary,Japan,€678.98]
Change %=−22.56%

### Response:

The Actual Capitals and Reserves for Foreign Subsidiary, Japan in Quart1, 2021 was €876.81, while in Quart4 it
decreased to €678.98 showing a decrease by 22.56%

### Data 7:

[Account,Entity,Period,Years,Scenario,Property,Value,Currency,Country,Version,Union Code,Component]
[EquityPerShare,Discover Bank,Q4,2001,Fcst vs Bud,OWP_CYTD(Prior),600 Billions,USD,USA,V1,Total Union,Total

### Component]

[EquityPerShare,Discover Bank,Q3,2001,Fcst vs Bud,OWP_CYTD(Prior),500 Billions,USD,USA,V1,Total Union,Total

### Component]

Change in amount=600−500=100
% Change=(100)/(500)=20%

### Response:

The EquityPerShare for Discover Bank, USA in Q3, 2001 under the ‘Fcst vs Bud’ scenario was 500 Billions USD for
Total Union and Total component of OWP_CYTD(Prior) property. It increased to 600 Billions USD in Q4, indicating
an increase of 100 Billions USD or 20%.

### ## Note:

Interpret values in parentheses as negative: Example: (2.5)% should be read as −2.5% Always compare from prior period to latest period.

### ## Task

### Input:

### Data:

{conditional_data}

### Response:

### Computer System Architecture

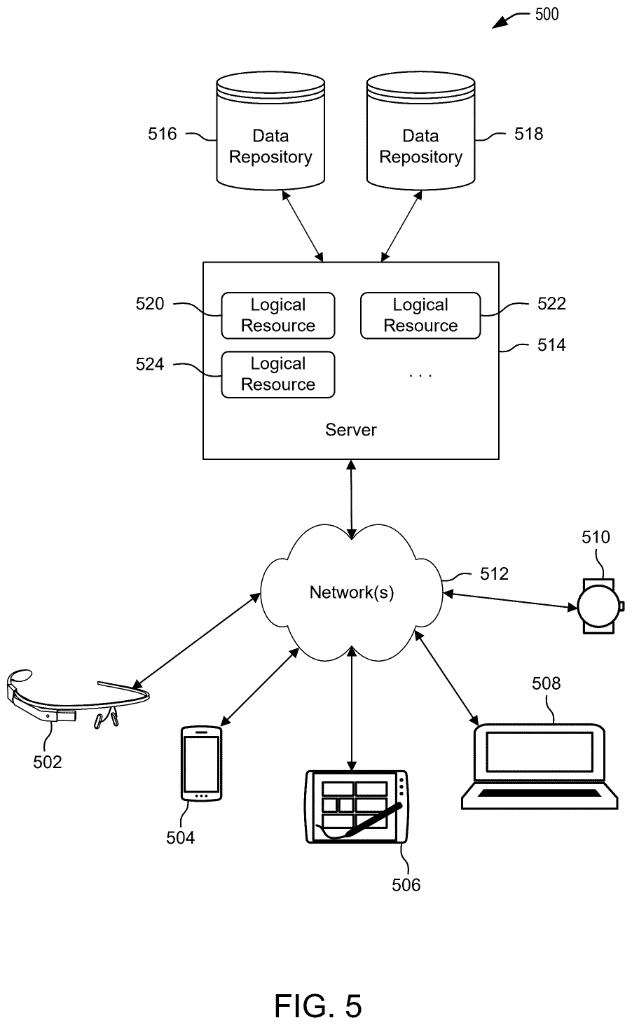

FIG. 5 depicts a simplified diagram of a distributed system 500 for implementing an embodiment. In the illustrated embodiment, distributed system 500 includes one or more client computing devices 502, 504, 506, 508, and/or 510 coupled to a server 514 via one or more communication networks 512. Clients computing devices 502, 504, 506, 508, and/or 510 may be configured to execute one or more applications.

In various aspects, server 514 may be adapted to run one or more services or software applications that enable techniques for detecting anomalies involving multiple dimensions, and generating a summary of the anomaly at least in part by prompting an LLM with key-value pairs relevant to the anomaly.

In certain aspects, server 514 may also provide other services or software applications that can include non-virtual and virtual environments. In some aspects, these services may be offered as web-based or cloud services, such as under a Software as a Service (SaaS) model to the users of client computing devices 502, 504, 506, 508, and/or 510. Users operating client computing devices 502, 504, 506, 508, and/or 510 may in turn utilize one or more client applications to interact with server 514 to utilize the services provided by these components.

In the configuration depicted in FIG. 5, server 514 may include one or more components 520, 522 and 524 that implement the functions performed by server 514. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, 508, and/or 510 for techniques for displaying information about detected anomalies involving multiple dimensions, and/or displaying a summary of the anomaly determined in accordance with the teachings of this disclosure. A client device may provide an interface that enables a user of the client device to interact with the client device. The client device may also output information to the user via this interface. Although FIG. 5 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 514 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 514 can include one or more virtual machines running virtual operating systems, or other computing architectures involving virtualization such as one or more flexible pools of logical storage devices that can be virtualized to maintain virtual storage devices for the server. In various aspects, server 514 may be adapted to run one or more services or software applications that provide the functionality described in the foregoing disclosure.

The computing systems in server 514 may run one or more operating systems including any of those discussed above, as well as any commercially available server operating system. Server 514 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 514 may include one or more applications to analyze and consolidate data feeds and/or event updates received from users of client computing devices 502, 504, 506, 508, and/or 510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 514 may also include one or more applications to display the data feeds and/or real-time events via one or more display devices of client computing devices 502, 504, 506, 508, and/or 510.

Distributed system 500 may also include one or more data repositories 516, 518. These data repositories may be used to store data and other information in certain aspects. For example, one or more of the data repositories 516, 518 may be used to store information for techniques for detecting anomalies involving multiple dimensions, and generating a summary of the anomaly at least in part by prompting an LLM with key-value pairs relevant to the anomaly. Data repositories 516, 518 may reside in a variety of locations. For example, a data repository used by server 514 may be local to server 514 or may be remote from server 514 and in communication with server 514 via a network-based or dedicated connection. Data repositories 516, 518 may be of different types. In certain aspects, a data repository used by server 514 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 516, 518 may also be used by applications to store application data. The data repositories used by applications may be of different types such as, for example, a key-value store repository, an object store repository, or a general storage repository supported by a file system.

In one embodiment, server 514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

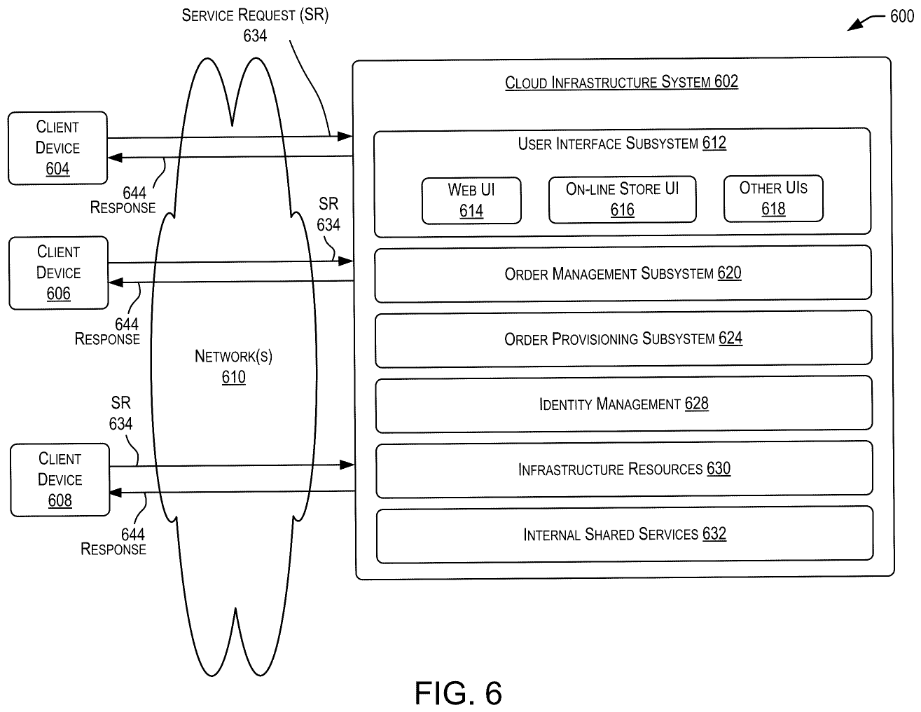

FIG. 6 is a simplified block diagram of a cloud-based system environment in which detects anomalies involving multiple dimensions, and generates a summary of the anomaly at least in part by prompting an LLM with key-value pairs relevant to the anomaly, in accordance with certain aspects. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 514. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other aspects, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative aspects.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 602. Cloud infrastructure system 602 then performs processing to provide the services requested in the tenant's subscription order. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public tenant, where the tenant can be an individual or an enterprise. In certain other aspects, under a private cloud model, cloud infrastructure system 602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 602 and the services provided may be shared by several organizations in a related community. Various other models such as hybrids of the above mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602.

In some aspects, the processing performed by cloud infrastructure system 602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain aspects, to facilitate efficient provisioning of these resources for supporting the various cloud services provided by cloud infrastructure system 602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a tenant may, using a client device, request (service request 634) one or more services provided by cloud infrastructure system 602 using one or more of interfaces 614, 616, and 618. For example, a tenant may access the online store, browse cloud services offered by cloud infrastructure system 602, and place a subscription order for one or more services offered by cloud infrastructure system 602 that the tenant wishes to subscribe to. The service request may include information identifying the tenant and one or more services that the tenant desires to subscribe to. For example, a tenant may place a subscription order for a chatbot related service offered by cloud infrastructure system 602. As part of the order, the client may provide information identifying the input (e.g. utterances).

In certain aspects, such as the embodiment depicted in FIG. 6, cloud infrastructure system 602 may comprise an order management subsystem (OMS) 620 that is configured to process the new order. As part of this processing, OMS 620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 602 may send a response or notification 644 to the requesting tenant to indicate when the requested service is now ready for use. In some instances, information (e.g., a link) may be sent to the tenant that enables the tenant to start using and availing the benefits of the requested services.

Cloud infrastructure system 602 may provide services to multiple tenants. For each tenant, cloud infrastructure system 602 is responsible for managing information related to one or more subscription orders received from the tenant, maintaining tenant data related to the orders, and providing the requested services to the tenant or clients of the tenant. Cloud infrastructure system 602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 602 may provide services to multiple tenants in parallel. Cloud infrastructure system 602 may store information for these tenants, including possibly proprietary information. In certain aspects, cloud infrastructure system 602 comprises an identity management subsystem (IMS) 628 that is configured to manage tenant's information and provide the separation of the managed information such that information related to one tenant is not accessible by another tenant. IMS 628 may be configured to provide various security-related services such as identity services, such as information access management, authentication and authorization services, services for managing tenant identities and roles and related capabilities, and the like.

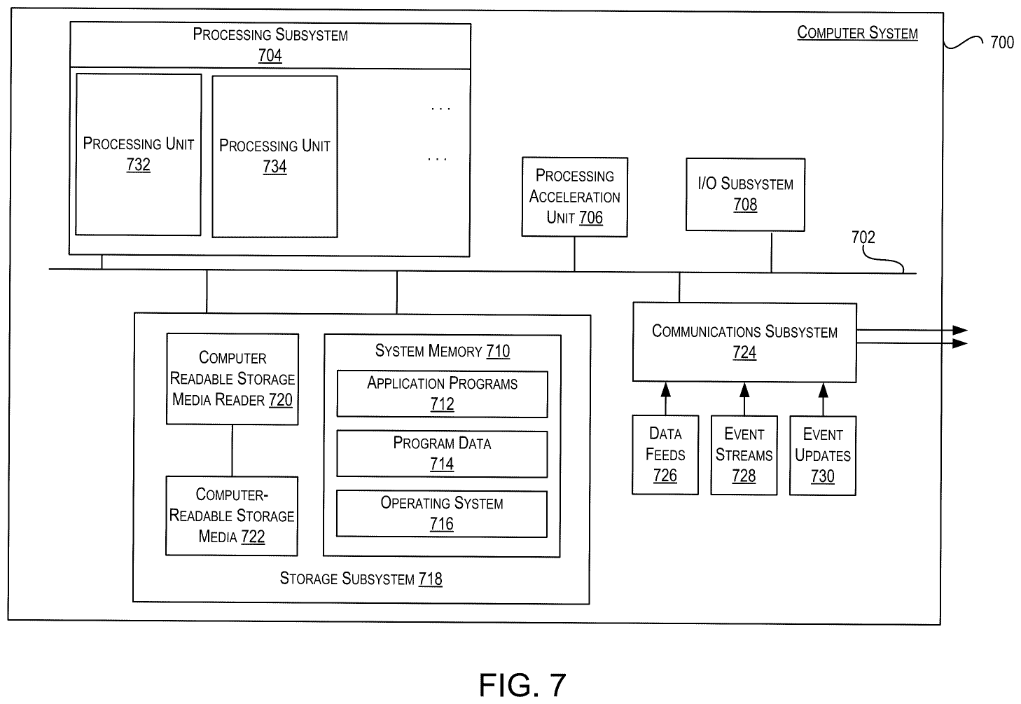

FIG. 7 illustrates an exemplary computer system 700 that may be used to implement certain aspects. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative aspects of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some aspects, processing subsystem 704 can include one or more special purpose co-processors such as graphics processors, digital signal processors (DSPs), or the like. In some aspects, some or all of the processing units of processing subsystem 704 can be implemented using customized circuits, such as application specific integrated circuits (ASICs), or field programmable gate arrays (FPGAs).

In some aspects, the processing units in processing subsystem 704 can execute instructions stored in system memory 710 or on computer readable storage media 722. In various aspects, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain aspects, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some aspects. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 722 may store programming and data constructs that provide the functionality of some aspects. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, digital video disc (DVD), a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 718 may also include a computer-readable storage media reader 720 that can further be connected to computer-readable storage media 722. Reader 720 may receive and be configured to read data from a memory device such as a disk, a flash drive, etc.

In certain aspects, computer system 700 may support virtualization technologies, including but not limited to virtualization of processing and memory resources. For example, computer system 700 may provide support for executing one or more virtual machines. In certain aspects, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices. For example, the communications subsystem may be used to transmit a response to a user regarding the inquiry for a chatbot.

Communications subsystem 724 may support both wired and/or wireless communication protocols. For example, in certain aspects, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 724 can provide wired network connectivity (e.g., Ethernet) in addition to or instead of a wireless interface.

Communications subsystem 724 can receive and transmit data in various forms. For example, in some aspects, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
detecting one or more conditions for an anomaly have been satisfied in multidimensional data;
generating one or more prompts comprising:
key value pairs corresponding to an anomaly field and an anomaly value and anomaly metadata comprising two or more dimension members that intersect in the multidimensional data where the anomaly is detected;
a plurality of other combinations of example key value pairs corresponding to other example anomalies;
a plurality of other example summaries of the other example anomalies that are based on the plurality of other combinations of example key value pairs;
prompting a large language model with the one or more prompts to generate a summary of the anomaly; and
causing display of the summary of the anomaly.

2. The computer-implemented method of claim 1, wherein keys of the key value pairs are stored in the one or more prompts as a key array and values of the key value pairs are stored in the one or more prompts as a value array; wherein a plurality of other keys of the plurality of other combinations of example key value pairs are stored in the one or more prompts as a plurality of other key arrays and a plurality of other values of the plurality of other combinations of example key value pairs are stored in the one or more prompts as a plurality of other value arrays.

3. The computer-implemented method of claim 1, wherein a drill-down dimension is stored in a user configuration in association with a monitor for the anomaly, wherein the one or more prompts further comprise:
key value pairs corresponding to one or more members of a drill-down dimension and one or more values of the one or more members.

4. The computer-implemented method of claim 3, wherein the one or more members comprise a Top N contributing members to the anomaly.

5. The computer-implemented method of claim 3, wherein the one or more members comprise a Bottom N contributing members to the anomaly.

6. The computer-implemented method of claim 1, wherein the one or more prompts further comprise:
key value pairs corresponding to one or more other calculated fields related to the anomaly.

7. The computer-implemented method of claim 6, wherein the one or more other calculated fields are identified based on a report that features the anomaly field.

8. The computer-implemented method of claim 1, wherein the one or more prompts further comprise key value pairs corresponding to a comparison between values from two different times with information indicating whether or how much the values changed between the two different times.

9. A computer-program product comprising one or more non-transitory machine-readable storage media, including stored instructions configured to cause a computing system to perform a set of actions including:
detecting one or more conditions for an anomaly have been satisfied in multidimensional data;
generating one or more prompts comprising:
key value pairs corresponding to an anomaly field and an anomaly value and anomaly metadata comprising two or more dimension members that intersect in the multidimensional data where the anomaly is detected;
a plurality of other combinations of example key value pairs corresponding to other example anomalies;
a plurality of other example summaries of the other example anomalies that are based on the plurality of other combinations of example key value pairs;
prompting a large language model with the one or more prompts to generate a summary of the anomaly; and
causing display of the summary of the anomaly.

10. The computer-program product of claim 9, wherein keys of the key value pairs are stored in the one or more prompts as a key array and values of the key value pairs are stored in the one or more prompts as a value array; wherein a plurality of other keys of the plurality of other combinations of example key value pairs are stored in the one or more prompts as a plurality of other key arrays and a plurality of other values of the plurality of other combinations of example key value pairs are stored in the one or more prompts as a plurality of other value arrays.

11. The computer-program product of claim 9, wherein a drill-down dimension is stored in a user configuration in association with a monitor for the anomaly, wherein the one or more prompts further comprise:
key value pairs corresponding to one or more members of a drill-down dimension and one or more values of the one or more members.

12. The computer-program product of claim 11, wherein the one or more members comprise a most relevant N contributing members to the anomaly.

13. The computer-program product of claim 10, wherein the one or more prompts further comprise key value pairs corresponding to a comparison between values from two different times with information indicating whether or how much the values changed between the two different times.

14. The computer-program product of claim 9, wherein the one or more prompts further comprise:
key value pairs corresponding to one or more other calculated fields related to the anomaly.

15. The computer-program product of claim 14, wherein the one or more other calculated fields are identified based on a report that features the anomaly field.

16. A system comprising:
one or more processors;
one or more non-transitory computer-readable media storing instructions, which, when executed by the system, cause the system to perform a set of actions including:
detecting one or more conditions for an anomaly have been satisfied in multidimensional data;
generating one or more prompts comprising:
key value pairs corresponding to an anomaly field and an anomaly value and anomaly metadata comprising two or more dimension members that intersect in the multidimensional data where the anomaly is detected;
a plurality of other combinations of example key value pairs corresponding to other example anomalies;
a plurality of other example summaries of the other example anomalies that are based on the plurality of other combinations of example key value pairs;
prompting a large language model with the one or more prompts to generate a summary of the anomaly; and
causing display of the summary of the anomaly.

17. The system of claim 16, wherein keys of the key value pairs are stored in the one or more prompts as a key array and values of the key value pairs are stored in the one or more prompts as a value array; wherein a plurality of other keys of the plurality of other combinations of example key value pairs are stored in the one or more prompts as a plurality of other key arrays and a plurality of other values of the plurality of other combinations of example key value pairs are stored in the one or more prompts as a plurality of other value arrays.

18. The system of claim 16, wherein a drill-down dimension is stored in a user configuration in association with a monitor for the anomaly, wherein the one or more prompts further comprise:
key value pairs corresponding to one or more members of a drill-down dimension and one or more values of the one or more members.

19. The system of claim 18, wherein the one or more members comprise a most relevant N contributing members to the anomaly.

20. The system of claim 17, wherein the one or more prompts further comprise key value pairs corresponding to a comparison between values from two different times with information indicating whether or how much the values changed between the two different times.

21. The system of claim 16, wherein the one or more prompts further comprise:
key value pairs corresponding to one or more other calculated fields related to the anomaly.
